(19) United States
(12) Patent Application Publication
(10) Pub. No.: US 2026/0149559 A1
(43) Pub. Date: May 28, 2026

(54) PROTECTION OF POLYNOMIAL CRYPTOGRAPHIC OPERATIONS AGAINST SIDE-CHANNEL ATTACKS WITH CHANGE-OF-VARIABLE TRANSFORMATIONS

(71) Applicant: Cryptography Research, Inc., San Jose, CA (US)

(72) Inventors: Mark Evan Marson, Carlsbad, CA (US); Helena Handschuh, Miami, FL (US); Michael Alexander Hamburg, Rosmalen (NL)

(21) Appl. No.: 19/122,157

(22) PCT Filed: Oct. 18, 2023
(86) PCT No.: PCT/US2023/035437

§ 371 Date: Apr. 17, 2025

Related U.S. Application Data
(60) Provisional application No. 63/417,414, filed on Oct. 19, 2022.

(51) Int. Cl. H04L 9/00; H04L 9/06; H04L 9/30

(52) U.S. Cl. CPC H04L 9/004; H04L 9/0631; H04L 9/3093

(57) ABSTRACT

Disclosed aspects and implementations are directed to systems and techniques for protecting cryptographic operations using change-of-variable transformation, from a first variable to a second variable, of a first polynomial obtained using an input into a cryptographic operation and a second polynomial obtained using a cryptographic key for the cryptographic operation, performing a joint operation using the transformed first polynomial and the transformed second polynomial, and computing an output of the cryptographic operation using an output of the joint operation.

### CLAIM OF PRIORITY

This application is a National Stage of International Application No. PCT/US23/35437, filed Oct. 18, 2023, which claims the benefit of U.S. Provisional Patent Application No. 63/417,414 filed Oct. 19, 2022, which is incorporated by reference herein.

### TECHNICAL FIELD

Aspects of the present disclosure are directed to cryptographic computing applications, more specifically to protection of cryptographic operations that use polynomial computations from side-channel attacks.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture capable of protecting secret data against side channel attacks using one or more CoV transformations in polynomial cryptographic operations, in accordance with one or more aspects of the present disclosure.

FIG. 2 is an example illustration of a random CoV transformation of secret data in polynomial operations performed in the course of cryptographic computations, for improved protection against side-channel attacks, in accordance with one or more aspects of the present disclosure.

FIG. 3 depicts a flow diagram of an example method of protection of polynomial cryptographic operations against side channel attacks using one or more random CoV transformations, in accordance with one or more aspects of the present disclosure.

FIG. 4 depicts a flow diagram illustrating implementations of a CoV-protected joint operation performed as part of the example method of FIG. 3, in accordance with one or more aspects of the present disclosure.

FIG. 5 depicts a block diagram of an example computer system 500 operating in accordance with one or more aspects of the present disclosure.

### DETAILED DESCRIPTION

In public-key cryptography systems, a processing device may have various components/modules used for cryptographic operations on input messages. Input messages used in such operations are often large positive integers. Examples of cryptographic operations include, but are not limited to operations involving Rivest-Shamir-Adelman (RSA) and Elliptic Curve Diffie-Hellman (ECDH) keys, Digital Signature Algorithms (DSA), Elliptic Curve Digital Signature Algorithms (ECDSA), and the like. Cryptographic algorithms can involve modular arithmetic operations with a publicly-known modulus. Pre-quantum cryptographic applications often exploit the fact that factorizing the public modulus into privately-stored prime multipliers is a prohibitively difficult operation for a classical computer.

Progress in development of quantum computers, however, has placed some of the conventional algorithms (RSA, DSA, ECDH, ECDSA) into jeopardy and motivated development of a number of post-quantum cryptographic algorithms, such as hash-based algorithms, code-based algorithms, multivariate algorithms, lattice-based algorithms, secret-key algorithms, symmetric key algorithms, and the like. Some of the post-quantum algorithms, e.g., the McEliece public key cryptosystem, use a representation of a ciphertext as a codeword with random errors. A private key allows to identify and remove errors from the codeword and to recover a plaintext encrypted in the codeword. Identifying errors may include finding roots of a large-degree polynomial (error-locator polynomial). Polynomials in McEliece cryptosystems, as well as other cryptosystems, are typically defined for a finite (Galois) field, GF(2^{mn}), e.g.,

$${\sum }_{j = 0}^{m - 1} {a}_{j} {x}^{j} ,$$

with the coefficients aⱼ defined on a finite field GF(2ⁿ) of characteristic 2 (e.g., with each coefficient aⱼ represented by n bits), addition operations

$${a}_{j} + {a}_{j}^{′}$$

defined using bitwise XOR (modulo 2) additions, element-level multiplications

$${a}_{j} + {a}_{k}^{′}$$

defined modulo a suitable irreducible polynomial of degree n, and polynomial-level multiplications

$${\sum }_{j = 0}^{m - 1} {a}_{j} {x}^{j} \cdot {\sum }_{k = 0}^{m - 1} {a}_{k}^{′} {x}^{k}$$

defined modulo another suitable irreducible polynomial of degree m in variable x with coefficients in GF(2ⁿ). It should be understood throughout this disclosure that characteristic 2 finite-field polynomial operations are used as illustration for conciseness and that operations in finite fields of any other characteristics (and/or infinite fields) may be protected with the techniques disclosed herein.

Polynomials in cryptographic operations may be used to represent various secret and public data. For example, a polynomial p(x) may represent (or may be derived from) a public data (e.g., a ciphertext communicated over open communication channels) and another polynomial s(x) may represent (or may be derived from) a secret data (e.g., a private cryptographic key securely stored in a location that is not publicly accessible). Public polynomial p(x) and secret polynomial s(x) are often used together in a joint computational operation to generate another secret polynomial q(x) (or multiple secret polynomials). Secret polynomial q(x) may then be used to decode a plaintext message encoded in the ciphertext. For example, in McEliece cryptosystems, secret polynomial q(x) may be obtained by applying the greatest common divisor (GCD) algorithm (or half-GCD algorithm) to polynomials p(x) and s(x) and may be used to construct an error-locator polynomial whose roots indicate positions of errors introduced into an error correction code (ECC) during encoding of the plaintext into an ECC codeword.

Cryptosystems that combine variable public data, e.g., polynomials p(x) with fixed secret data, e.g., polynomials s(x), may be vulnerable to side-channel attacks, if an attacker is able to generate large numbers of public polynomials p(x) and observe joint processing of such polynomials with a secret polynomial s(x). In particular, a side-channel attack may be performed by monitoring signals produced by electronic circuits of a targeted computer. Monitored signals may be acoustic, electric, magnetic, optical, thermal, and so on. By recording signals, a hardware trojan and/or a malicious software may correlate specific processor (and/or memory) activity with operations carried out by the processor. A simple power analysis (SPA) side-channel attack may involve examination of the electric power used by the device as a function of time. As the presence of noise hides the signal of the processor, a more sophisticated differential power analysis (DPA) attack may involve undertaking statistical analysis of power measurements performed over multiple cryptographic operations (or multiple iterations of a single cryptographic operation). An attacker employing DPA may filter out the noise component of the power signal (using the fact that the noise components may be uncorrelated between different operations or iterations) to extract the component of the signal that is representative of the actual processor operations, and to infer the value of the private key from this signal. During an attack (e.g., a template attack), an attacker accesses an attacker-controlled copy of the targeted computer and generates plaintext outputs for multiple ciphertext inputs (or ciphertext outputs for multiple plaintext inputs), in which known data (e.g., polynomials p(x)) is repeatedly combined with secret data (e.g., polynomials s(x)).

Aspects and implementations of the present disclosure address these and other challenges of the existing technology by enabling systems and techniques of efficiently transforming secret polynomials for enhanced cryptographic protection of confidential data. In some implementations, prior to performing a joint operation on polynomials p(x) and s(x), the variable (indeterminate) x may be transformed using an invertible change-of-variable (CoV) transformation, x′=M(x) resulting in a new representation for these polynomials. In some implementations, the randomizing transformation may be an affine linear transformation, M(x)=ax+β, where α and β may be random elements of the field in which the calculations take place, such that α≠0. The transformation may change the representation of polynomials p(x) and s(x) to transformed polynomials, p(x)→p(x′)=p(M(x))≡P(x) and s(x)→s(x′)=s(M(x))≡S(x). The joint operation may then be performed using transformed polynomials P(x) and S(x). The resulting polynomial Q(x) (e.g., intermediate output of a cryptographic operation) may be used to determine the inverse-transformed polynomial q(x), using the inverse CoV transformation M⁻¹(x), q(x)=Q(M⁻¹(x)). Such CoV transformation/inverse CoV transformation prevents an attacker from collecting statistics sufficient for determining the secret data. In some implementations, an error-localization procedure, e.g., identifying roots of the polynomial q(x), may be executed using the transformed polynomial Q(x) directly. The set of roots {Rᵢ} of a transformed error-locator polynomial Σ(x) (e.g., which may be obtained using the intermediate output Q(x)) may be converted into roots of the target error-locator polynomial σ(x) (or any other polynomial obtained based on q(x), as may be specified by a particular cryptographic algorithm) using the CoV transformation: {Rᵢ}→{rᵢ}={M(Rᵢ)}. In some implementations, prior to identifying roots of the error-locator polynomial Σ(x), an additional change of variables transformation, x″=M′(x) may be applied. This replaces the intermediate output polynomial representation by Q(x)→Q′(x)=Q(M′(x))=q(M(M′(x)). Correspondingly, the set of transformed roots {R′ᵢ} of the re-transformed polynomial Σ′(x) may be identified and then converted into roots of the target error-locator polynomial σ(x) as follows: {R′ᵢ}→{rᵢ}={M(M′(R′ᵢ))}, which amounts to applying the combined CoV transformation M(M′(⋅)) to the roots of Σ′(x).

Numerous additional implementations are disclosed herein. The advantages of the disclosed implementations include, but are not limited to, secure execution of cryptographic applications deploying polynomial operations by enabling enhanced protection of secret information against side-channel attacks and other unauthorized accesses. The disclosed implementations may be used in public key cryptography (e.g., McEliece cryptographic systems), symmetric key cryptography, digital signature algorithms, or any algorithms that use polynomial operations.

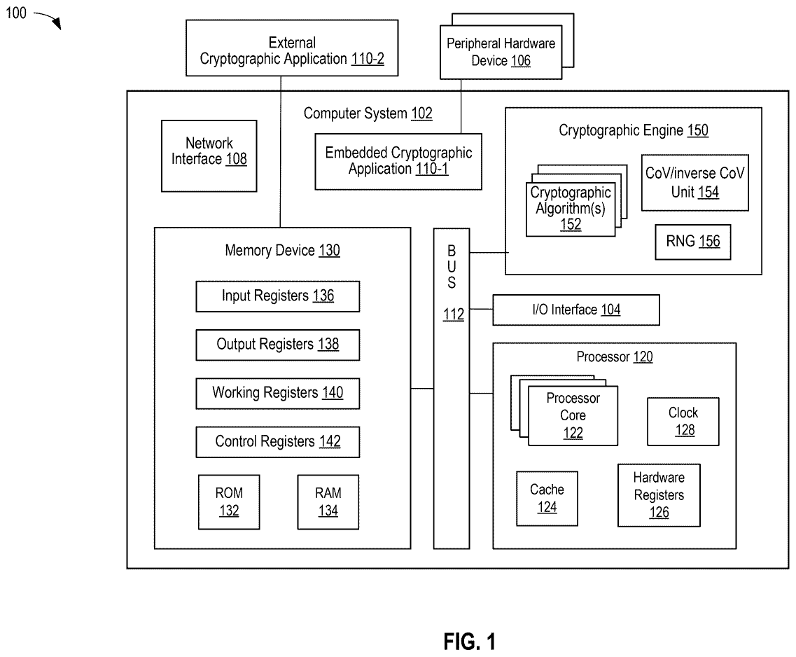

FIG. 1 is a block diagram illustrating an example system architecture 100 capable of protecting secret data against side channel attacks using one or more CoV transformations in polynomial cryptographic operations, in accordance with one or more aspects of the present disclosure. Example system architecture 100 may be a desktop computer, a tablet, a smartphone, a server (local or remote), a thin/lean client, and the like. Example system architecture 100 may be a smart card reader, a wireless sensor node, an embedded system dedicated to one or more specific applications (e.g., cryptographic applications 110-n), and so on. Example system architecture 100 may include (but need not be limited to) a computer system 102 having one or more processors 120 (e.g., central processing units (CPUs)) capable of executing binary instructions, and one or more memory devices 130. Herein “processor” or “processing device” refers to a device capable of executing instructions encoding arithmetic, logical, or I/O operations. In one illustrative example, a processing device may follow Von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Example system architecture 100 may include an input/output (I/O) interface 104 to facilitate connection of computer system 102 to peripheral hardware devices 106 such as card readers, terminals, printers, scanners, internet-of-things devices, and the like. Example system architecture 100 may further include an internet interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computer system 102. Various hardware components of the computer system 102 may be connected via a bus 112, which may have its own logic circuits, e.g., a bus interface logic unit.

Example computer system 102 may support one or more cryptographic applications 110-n, such as an embedded cryptographic application 110-1 and/or external cryptographic application 110-2. Cryptographic applications 110-n may be secure authentication applications, public key signature applications, key encapsulation applications, key decapsulation applications, encrypting applications, decrypting applications, secure storage applications, and so on. External cryptographic application 110-2 may be instantiated on the same computer system 102, e.g., by an operating system executed by the processor 120 and residing in a memory device 130. Alternatively, external cryptographic application 110-2 may be instantiated by a guest operating system supported by a virtual machine monitor (hypervisor) executed by the processor 120. In some implementations, external cryptographic application 110-2 may reside on a remote access client device or a remote server (not shown), with the computer system 102 providing cryptographic support for the client device and/or the remote server.

Processor 120 may include one or more processor cores 122 having access to cache 124 (e.g., a single-level or multi-level cache) and one or more hardware registers 126. In some implementations, each processor core 122 may execute instructions to run a number of hardware threads, also known as logical processors. Various logical processors (or processor cores) may be assigned to one or more cryptographic applications 110-n, although more than one processor may be assigned to a single cryptographic application for parallel processing. Memory device 130 may refer to a volatile or non-volatile memory and may include a read-only memory (ROM) 132, a random-access memory (RAM) 134, as well as (not shown) electrically erasable programmable read-only memory (EEPROM), flash memory, flip-flop memory, or any other device capable of storing data. RAM 134 may be a dynamic random access memory (DRAM), synchronous DRAM (SDRAM), a static memory, such as static random access memory (SRAM), and the like.

Memory device 130 may include one or more registers, such as one or more input registers 136 to store cryptographic keys, input polynomials, and other data for cryptographic applications 110-n. Memory device 130 may further include one or more output registers 138 to store outputs of cryptographic application, and one or more working registers 140 to store various intermediate values generated in the course of performing cryptographic computations, including CoV transformations and transformed polynomials. Memory device 130 may also include one or more control registers 142 for storing information about modes of operation, selecting a cryptographic algorithm, initializing cryptographic computations, selecting a masking mode, e.g., initial CoV transformation, subsequent (additional) CoV transformation, CoV re-transformation, and so on. Control registers 142 may communicate with one or more processor cores 122 and a clock 128, which may keep track of an iteration being performed. In some implementations, Registers 136-142 may be implemented as part of RAM 134. In some implementations, some or all of the registers 136-142 may be implemented separately from RAM 134. Some of or all registers 136-142 may be implemented as part of processor 120 (e.g., as part of the hardware registers 126). In some implementations, processor 120 and memory device 130 may be implemented as a single field-programmable gate array (FPGA).

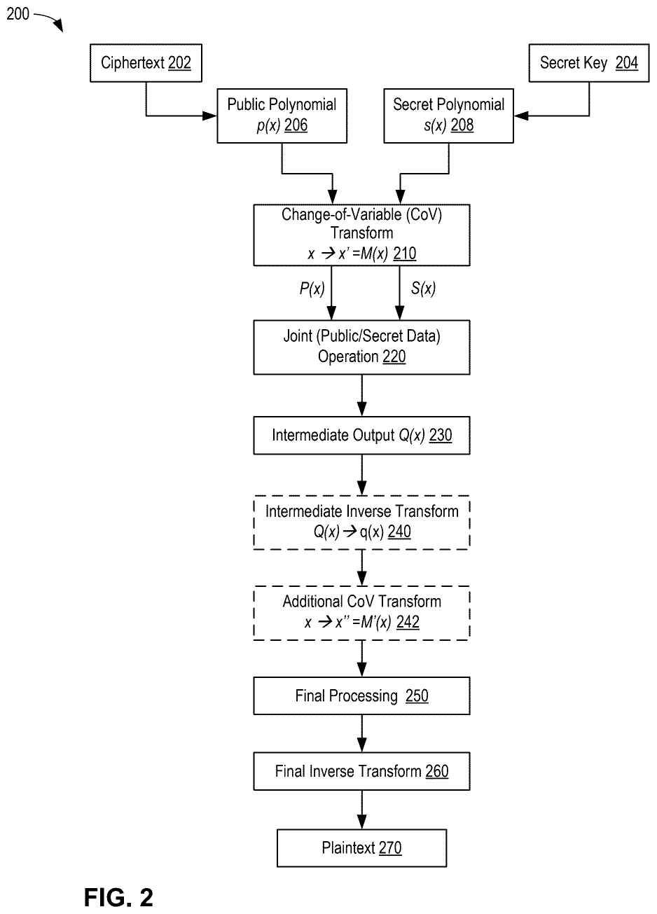

Computer system 102 may include a cryptographic engine 150 to support cryptographic operations of processor 120. Cryptographic engine 150 may be configured to perform side channel attack-resistant cryptographic operations, in accordance with implementations of the present disclosure. Cryptographic engine 150 may be a separate hardware component, e.g., as depicted in FIG. 1. In some implementations, cryptographic engine 150 may be implemented as a software (or firmware) module instantiated in memory device 130. In some implementations, cryptographic engine 150 may be partially implemented as a hardware component and partially as a software (or firmware) module. Cryptographic engine 150 may include one or more cryptographic algorithm units 152 that performs cryptographic computations as may be specified by a particular cryptographic system. Cryptographic computations performed by cryptographic algorithm units 152 may include polynomial-based computations. Cryptographic engine 150 may include a CoV transformation/inverse CoV transformation unit 154 that protects operations of cryptographic algorithm units 152 against side-channel attacks by randomizing variables (indeterminates) and coefficients of various polynomials used in polynomial-based computations, e.g., as described in more detail in conjunction with FIG. 2 below. Cryptographic engine 150 may further include a random number generator (RNG) 156 to generate various randomizing transformations, etc., as may be used by cryptographic algorithm units 152 and CoV transformation/inverse CoV transformation unit 154.

FIG. 2 is an example illustration of a CoV transformation 200 of secret data in polynomial operations performed in the course of cryptographic computations, for improved protection against side-channel attacks, in accordance with one or more aspects of the present disclosure. In some implementations, CoV transformation 200 may be performed by various components and/or modules of cryptographic engine 150 of FIG. 1. In some implementations, CoV transformation 200 may be performed in the course of decryption of a ciphertext 202, which may be any message encrypted by a suitable cryptographic system, e.g., McEliece cryptographic system, RSA cryptographic system, Elliptic Curve cryptographic system, digital signature algorithms, lattice-based cryptographic systems (e.g., NTRUEncrypt and NTRUSign cryptosystems), Rijndael cryptographic system, Advanced Encryption Standard cryptographic system, and the like. Decryption of ciphertext 202 may involve using a secret key 204, which may be any cryptographic key permanently stored on computer system 102, ephemeral key or session key generated for a particular cryptographic episode, key generated to decrypt a particular message or a portion of a message, and the like. In some implementations, ciphertext 202 may have been obtained from a plaintext message by computing a multiplication product of a numerical representation (vector) of the plaintext message and a publicly available generating matrix and then corrupting the computed product by adding a vector of randomly generated errors.

Ciphertext 202 may be used to generate a public polynomial p(x) 206, which in McEliece cryptosystems may be a syndrome polynomial that contains information about locations of the randomly generated errors. A secret polynomial s(x), e.g., a Goppa polynomial or any other suitable polynomial, may be obtained using secret key 204. Public polynomial p(x) 206 and secret polynomial s(x) 208 may be used to perform a joint operation 220. Joint operation 220 may be any operation whose output q(x) depends on both the public polynomial p(x) 206 and the secret polynomial s(x) 206. For example, joint operation 220 may include determining q(x) that is a GCD of public polynomial p(x) 206 and secret polynomial s(x) 208:

$$a ( x ) \cdot p ( x ) + b ( x ) \cdot s ( x ) = q ( x ) ,$$

with some polynomials a(x) and b(x) that may be computed in the course of execution of the GCD algorithm. Determining the GCD polynomial q(x) may be performed, e.g., using the Extended Euclidean Algorithm. In some implementations, e.g., in McEliece cryptosystems, joint operation 220 may include performing an extended half-GCD algorithm. This amounts to finding determining q(x) for the public polynomial p(x) 206 and the secret polynomial s(x) 208, such that

$$a ( x ) \cdot p ( x ) + b ( x ) \cdot s ( x ) = q ( x ) ,$$

where the degree of secret polynomial s(x) 208 is t, the degree of polynomial q(x) is less than or equal to [t/2], and the degree of polynomial σ(x) is less than or equal to [(t−1)/2]. (For example, the extended half-GCD algorithm may be performed using full GCD iterations that are stopped once the two conditions on the polynomials q(x) and a(x) is satisfied.) In some implementations, the GCD polynomial reduces to unity, q(x)=1, and the extended GCD algorithm amounts to computing an inverse of p(x) modulo s(x) (e.g., to obtain a(x)) or an inverse of s(x) modulo p(x) (e.g., to obtain b(x)). The polynomial q(x) represents an intermediate output of the decryption operation and may be used for final processing 250, which computes the final output, e.g., plaintext 270. For example, intermediate output q(x) may be used to construct an error-locator polynomial, e.g., a(x)=[q(x)]²+x·[a(x)]², or any other suitable polynomial as may be specified by a cryptographic algorithm. The locator polynomial σ(x) may be used to identify locations of errors introduced during encryption e.g., as part of final processing 250.

To protect joint operation 220, CoV transformation 210 may be applied to public polynomial p(x) 206 and secret polynomial s(x) 208. CoV transformation 210 refers to a random invertible transformation of the indeterminate x of the polynomial. Change of variables transformation 210 may include applying an invertible transformation,

$${x}^{′} = M ( x ) .$$

In some implementations, the CoV transformation may be an affine linear transformation, M(x)=αx+β, where α and β may be elements in a field on which the polynomials are defined, e.g., GF(2ⁿ), a field of characteristic other than 2, or any other suitable field. In some implementations, one or both of α and/or β may be random elements (with α≠0) in GF(2^{m}), e.g., generated by RNG 156 depicted in FIG. 1. The CoV transformation may amount to a change of the representation of polynomials p(x) and s(x) to transformed polynomials, P(x) and S(x),

$$p ( x ) \to p ( {x}^{′} ) = p ( M ( x ) ) ≡ P ( x ) ,$$

$$s ( x ) \to s ( {x}^{′} ) = s ( M ( x ) ) ≡ S ( x ) .$$

In the instances of affine linear CoV transformations, CoV does not change the degree of the polynomials.

It should be understood that polynomials, e.g.,

$$p ( x ) = {\sum }_{j = 0}^{m - 1} {p}_{j} {x}^{j} ,$$

in the variable (indeterminate) x are be considered as an abstraction-level representation of various computational operations, and that the variable x itself need not be stored or referenced by memory device 130 and/or cryptographic engine 150. In particular, polynomial p(x) (as well as other encountered or computed polynomials) may be stored (and operated on) as m data units (symbols, words, etc.) pⱼ (or as t+1 data units, if the degree t of the polynomial is less than m−1), each data unit pⱼ having n bits. For example, each pⱼ may be one-byte data units corresponding to elements in GF(2⁸). This polynomial abstraction may be understood as specifying the same computational operations (e.g., additions, multiplications, etc.) performed on the data units pⱼ as would have resulted from corresponding operations performed on the respective coefficients pⱼ of the polynomial

$$p ( x ) = {\sum }_{j = 0}^{m - 1} {p}_{j} {x}^{j} .$$

Similarly, operations of a CoV transformation may be understood as being performed on the data units in the same way as would have resulted from the corresponding transformation operations performed upon transforming the variable x of the polynomial p(x). For example, for a third-degree polynomial p(x)=p₃x³+p₂x²+p₁x+p₀, an affine linear randomizing transformation for the variable x→x′=αx+β may be understood as the following transformation for the coefficients, pⱼ→Pⱼ.

$${p}_{0} \to {P}_{0} = {p}_{3} \cdot {β}^{3} + {p}_{2} \cdot {β}^{2} + {p}_{1} \cdot β + {p}_{0} ,$$

$${p}_{1} \to {P}_{1} = ( {p}_{3} \cdot {β}^{2} + {p}_{1} ) \cdot α ,$$

$${p}_{2} \to {P}_{2} = ( {p}_{3} \cdot β + {p}_{2} ) \cdot {α}^{2} ,$$

$${p}_{3} \to {P}_{3} = {p}_{3} \cdot {α}^{3} ,$$

as would have resulted from the CoV transformation x→x′ of the respective polynomial,

$$p ( x ) = {\sum }_{j = 0}^{m - 1} {p}_{j} {x}^{j} \to P ( x ) = p ( {x}^{′} ) = {\sum }_{j = 0}^{m - 1} {p}_{j} {x}^{′j} = {\sum }_{j = 0}^{m - 1} {{p}_{j} ( αx + β )}^{j} = {\sum }_{j = 0}^{m - 1} {P}_{j} {x}^{j} .$$

Joint operation 220 may be performed based on the transformed polynomials P(x) and S(x). Joint operation 220 may be performed using substantially the same computations as described above for the inverse-transformed polynomials p(x) and s(x). For example, in McEliece cryptosystems, where joint operation 220 may execute the half-GCD algorithm, joint operation 220 may compute such polynomials A(x) and Q(x), that:

$$A ( x ) \cdot P ( x ) + B ( x ) \cdot S ( x ) = Q ( x ) ,$$

and where the degree of masked secret polynomial S(x) is t, the degree of intermediate output polynomial Q(x) is less than or equal to [t/2], and the degree of polynomial A(x) is less than or equal to [(t−1)/2].

Intermediate transformed output polynomial Q(x) 230 (and other intermediate outputs, e.g., polynomials A(x), B(x), etc.) may undergo inverse transformation 240, e.g., inverse CoV transformation,

$$q ( x ) = Q ( {M}^{- 1} ( x ) ) ,$$

In some implementations, the CoV transformation may be an affine linear transformation, M(x)=αx+β, where α and β may be elements in any suitable field, e.g., GF(2ⁿ) or any other field over which the polynomials are defined. For example, a and β may be random elements (with α≠0), generated by RNG 156. e.g., M⁻¹(x)=a⁻¹·(x−β), in the instances of linear CoV. Similar inverse transformations may be performed for other intermediate polynomials A(x), B(x), and so on. In some implementations, final processing 250 of intermediate output(s) may be performed on original polynomials, e.g., a(x)=[q(x)]²+x·[a(x)]². In some implementations, final processing 250 may be performed on transformed polynomials. For example, during final processing 250, roots of transformed locator polynomial Σ(x)=[Q(x)]²+M(x)·[A(x)]² may be identified. The identified roots {Rᵢ} of the polynomial Σ(x) (or any other polynomial obtained based on Q(x), as may be specified by a particular cryptographic algorithm) may be converted into roots {rᵢ} of the (original) locator polynomial σ(x) using the same CoV transformation: {Rᵢ}→{rᵢ}={M(Rᵢ)}, e.g., as part of final inverse transformation 260. Search for the roots {rᵢ}(if the inverse transformation is performed prior to identification of the roots) or roots {Rᵢ}(if the inverse transformation is performed after identification of the roots) may be performed using any suitable root-finding algorithm, e.g., direct search, additive Fast Fourier Transform techniques, Chien search, and so on.

In some implementations, prior to performing final processing 250, e.g., prior to identifying roots of the locator polynomial (or performing any other polynomial operation, as may be specified by a particular deployed cryptographic algorithm), additional CoV transformation 242 may be performed. Additional CoV transformation 242 may be performed after intermediate inverse transformation 240 or instead of intermediate inverse transformation 240. More specifically, additional CoV transformation 242 may include performing a second invertible CoV transformation, x″=M′(x), which may be another affine linear transformation, M′(x)=α′x+β′. In some implementations, α′ and β′ may random be elements in GF(2ⁿ) or any other field over which the polynomial computations are defined, generated by RNG 156 illustrated in FIG. 1. Additional CoV transformation 242 replaces intermediate output polynomial representations Q(x)→Q′(x)=Q(M′(x)), A(x)→A′(x)=A(M′(x)), and similarly for other intermediate output polynomial representations. The additionally transformed (re-transformed) intermediate output polynomial representations may then be used for final processing 250, as described above.

For example, a set of transformed roots {R′ⱼ} of the locator polynomial Σ(M′(x)) in a second representation may be identified as part of final processing 250. The set of transformed roots {R′ⱼ} may then be converted, e.g., as part of final inverse transformation 260, into roots {rᵢ} of the target locator polynomial σ(x) in the original representation as follows:

$$\{ {R}_{i}^{′} \} \to \{ {r}_{i} \} = \{ M ( {M}^{′} ( {R}_{i}^{′} ) ) \} ,$$

which amounts to applying the combined CoV transformation M(M′(⋅)) to the roots of the transformed error-locator polynomial. For example, in the instances of two linear transformations M(⋅) and M′(⋅), the roots of the error-locator polynomial may be obtained by the combined transformation,

$${r}_{i} = ( α \cdot {α}^{′} ) {R}_{i}^{′} + α \cdot {β}^{′} + β ,$$

Plaintext 270 may then be obtained using the roots of the error-locator polynomial, e.g., by removing the errors with known locations from the codeword.

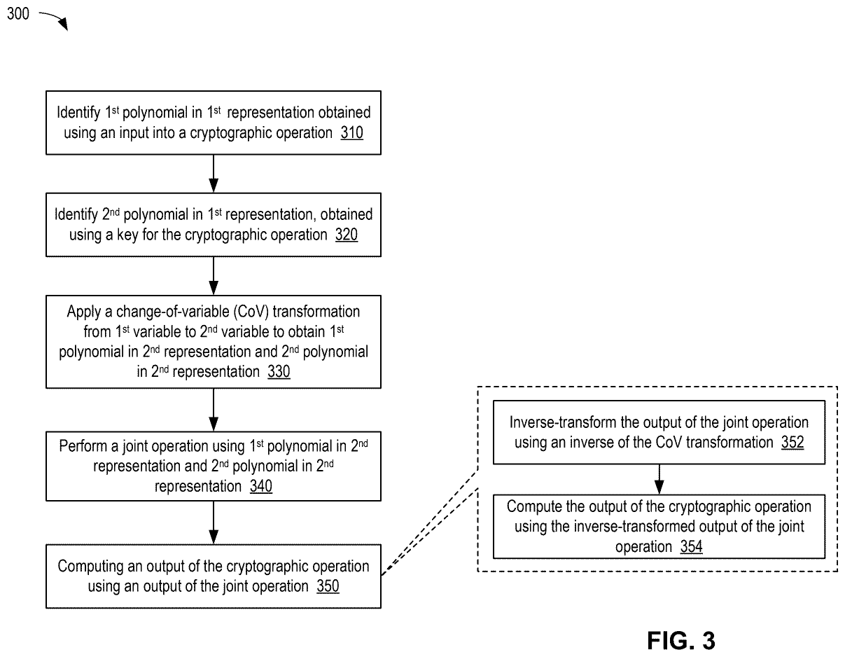

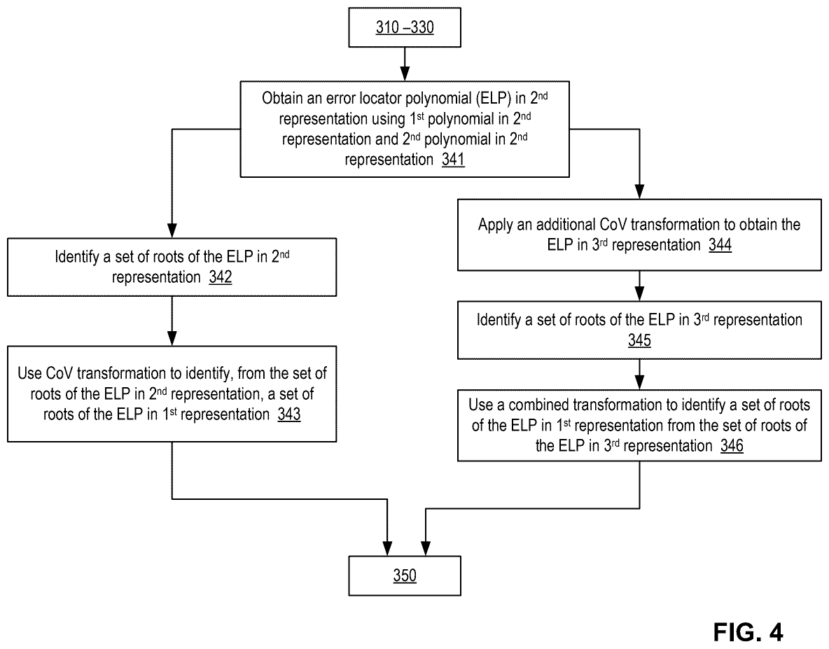

FIG. 3 depicts a flow diagram of an example method 300 of protection of polynomial cryptographic operations against side channel attacks using one or more random CoV transformations, in accordance with one or more aspects of the present disclosure. Method 300 disclosed below, and/or each of its individual functions, routines, subroutines, or operations may be performed by one or more processing units of the computing system implementing the respective methods, e.g., processor 120 of computer system 102. In some implementations, method 300 may be performed by an arithmetic logic unit, an FPGA, an ASIC, a cryptographic accelerator, a dedicated hardware circuit, and the like, or any suitable processing logic, hardware or software or a combination thereof. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other. Various operations of method 300 may be performed in a different order compared with the order shown in FIG. 3 (and/or order shown in FIG. 4). Some blocks may be performed concurrently with other blocks. Some blocks of method 300 may be optional.

Method 300 may be performed by one or more processing units of computer system 102, e.g., processor 120. In some implementations, a cryptographic operation protected by method 300 may include decrypting a ciphertext input and recovering a plaintext output encrypted in the ciphertext input. In some implementations, the cryptographic operation may be performed as part of McEliece public key encryption/decryption cryptography, e.g., a McEliece decryption operation, or performed as part of any public key or symmetric cryptography. At block 310, method 300 may include identifying, by a processing device, a first polynomial (e.g., public polynomial p(x) 206 in FIG. 1) in a first representation. In some implementations, the first polynomial may be obtained using an input into the cryptographic operation, which may be a ciphertext. In some implementations, the first polynomial and/or the second polynomial may be a polynomial in a GF(2^{m}) field, where m=128, 256, 1024, or some other integer number. Coefficients of the first polynomial and/or the second polynomial may be elements of a GF(2ⁿ) field, where n=2, 4, 8, 16, or some other integer number. In some implementations, coefficients of the first polynomial may be elements of any other finite field or an infinite field. At block 320, method 300 may include identifying a second polynomial (e.g., secret polynomial s(x) 208 in FIG. 1) in the first representation. In some implementations, the second polynomial may be obtained using a cryptographic key for the cryptographic operation.

At block 330, method 300 may continue with the processing device applying a CoV transformation from the first variable to a second variable (e.g., x→x′=M(x)) to the first polynomial to obtain the first polynomial in a second representation. As described in more detail above, applying the CoV transformation may amount to a change of the coefficients (data units) of the first polynomial pⱼ→Pⱼ as specified by the CoV transformation, p(x)→p(x′)=p(M(x))≡P(x). The processing device may further apply the CoV transformation (from the first variable to the second variable) to the second polynomial s(x)→s(x′)=s(M(x))≡S(x) to obtain the second polynomial in the second representation. In some implementations, the CoV transformation may be an invertible transformation from the first variable to the second variable. In some implementations, the invertible transformation may be an affine linear transformation from the first variable to the second variable (e.g., M(x)=αx+β).

At block 340, method 300 may continue with the processing device performing a joint operation using the first polynomial in the second representation (e.g., P(x)) and the second polynomial in the second representation (e.g., S(x)). The joint operation may be any suitable operation whose output depends on the value of the first polynomial and the second polynomial. In some implementations, performing the joint operation may include executing the extended GCD algorithm for the transformed first polynomial and the transformed second polynomial. In some implementations, performing the joint operation may include executing the extended half-GCD algorithm for the first polynomial in the second representation and the second polynomial in the second representation. In some implementations, performing the joint operation may include executing an algorithm computing an inverse of one of (i) the first polynomial in the second representation or (ii) the second polynomial in the second representation modulo another one of (i) the first polynomial in the second representation or (ii) the second polynomial in the second representation.

At block 350, method 300 may include computing, by the processing device, an output of the cryptographic operation using the output of the joint operation (e.g., polynomial Q(x), polynomial Σ(x), and so on). In some implementations, computing the output of the cryptographic operation may include performing operations illustrated in the callout portion of FIG. 3. More specifically, at block 352, the processing device performing method 300 may inverse-transform the output of the joint operation using an inverse of the CoV transformation (e.g., Q(x)→Q(y)=Q(M⁻¹(x))≡q(x)). At block 354, method 300 may include computing the output of the cryptographic operation using the inverse-transformed output of the joint operation.

FIG. 4 depicts a flow diagram illustrating implementations of a CoV-protected joint operation performed as part of example method 300 of FIG. 3, in accordance with one or more aspects of the present disclosure. In some implementations, operations of block 340 of method 300 may include, at block 341, obtaining a transformed error-locator polynomial (ELP) (e.g., polynomial Σ(x)) using the transformed first polynomial and the transformed second polynomial. In one example (left branch in FIG. 4), method 300 may include, at block 342, identifying a first set of roots of the transformed ELP (e.g., {Rᵢ}). The first set of roots may be associated with the polynomial in its second representation. At block 343, method 300 may include using the CoV transformation to identify, from the first set of roots of the ELP in the second representation, a second set of roots of an original ELP in the first representation (e.g., {Rᵢ}→{rᵢ}={M(Rᵢ)}). The second set of roots (e.g., {rᵢ}) may be associated with the polynomial in the first representation (e.g., {rᵢ} may be the roots of the original ELP a(x)).

In another example (right branch in FIG. 4), method 300 may include, at block 344, applying an additional CoV transformation (e.g., x″=M′(x)) from the first variable to a third variable to obtain the ELP (e.g., Σ′(x)) in a third representation. The ELP in the third representation may be related to the ELP (e.g., a(x)) in the first representation via a combined transformation (e.g., Σ′(x)=a(M(M′(x))), in one example). At block 345, method 300 may continue with identifying a first set of roots of the re-transformed ELP (e.g., set {R′ᵢ}) in a third representation, and at block 346 may include using the combined transformation to identify, from the first set of roots of the re-transformed ELP, a second set of roots of an original ELP (e.g., {R′ᵢ}→{rᵢ}={M(M′(R′ᵢ))}). The second set of roots (e.g., {rᵢ}) may be associated with the ELP polynomial in its original (first) representation, and the combined transformation may be based on the CoV transformation (e.g., M(⋅)) and the additional CoV transformation (e.g., M′(⋅)).

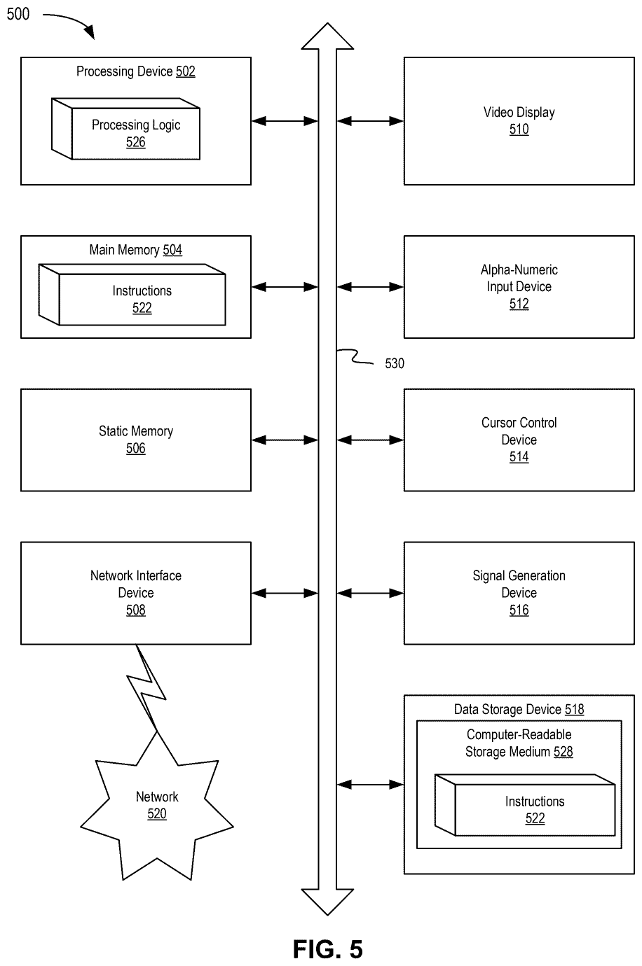

FIG. 5 depicts a block diagram of an example computer system 500 operating in accordance with one or more aspects of the present disclosure. In various illustrative examples, computer system 500 may represent computer system 102, illustrated in FIG. 1. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), which may include processing logic 526, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing method 300 of protection of polynomial cryptographic operations against side channel attacks using CoV transformations.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing method 300 of protection of polynomial cryptographic operations against side channel attacks using CoV transformations.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a cryptographic operation, the method comprising:
identifying, by a processing device, a first polynomial in a first representation, the first polynomial obtained using an input into the cryptographic operation;
identifying, by the processing device, a second polynomial in the first representation, the second polynomial obtained using a cryptographic key for the cryptographic operation;
applying, by the processing device, a change-of-variable (CoV) transformation to the first polynomial in the first representation to obtain the first polynomial in the second representation;
applying, by the processing device, the CoV transformation to the second polynomial in the first representation to obtain the second polynomial in the second representation;
performing, by the processing device, a joint operation using the first polynomial in the second representation and the second polynomial in the second representation; and
computing, by the processing device, an output of the cryptographic operation using an output of the joint operation.

2. The method of claim 1, wherein the input into the cryptographic operation comprises a ciphertext and the output of the cryptographic operation comprises a plaintext encrypted in the ciphertext.

3. The method of claim 1, wherein the CoV transformation comprises an invertible transformation from a first variable to a second variable.

4. The method of claim 3, wherein the invertible transformation comprises an affine linear transformation from the first variable to the second variable.

5. The method of claim 1, wherein each of the first polynomial and second polynomial is a polynomial with coefficients in a field GF(2^{m}), wherein m is an integer number.

6. The method of claim 1, wherein computing the output of the cryptographic operation comprises:
inverse-transforming the output of the joint operation using an inverse of the CoV transformation; and
computing the output of the cryptographic operation using the inverse-transformed output of the joint operation.

7. The method of claim 1, wherein performing the joint operation comprises executing at least one of:
an extended greatest common divisor (GCD) algorithm for the first polynomial in the second representation and the second polynomial in the second representation;
an extended half-GCD algorithm for the first polynomial in the second representation and the second polynomial in the second representation; or
an algorithm computing an inverse of one of (i) the first polynomial in the second representation or (ii) the second polynomial in the second representation modulo another one of (i) the first polynomial in the second representation or (ii) the second polynomial in the second representation.

8. The method of claim 1, wherein performing the joint operation comprises:
obtaining an error-locator polynomial (ELP) in the second representation using the first polynomial in the second representation and the second polynomial in the second representation; and
identifying a set of roots of the ELP in the second representation.

9. The method of claim 8, wherein performing the joint operation further comprises:
using the CoV transformation to identify, from the set of roots of the ELP in the second representation, a set of roots of the ELP in the first representation.

10. The method of claim 1, wherein performing the joint operation comprises:
obtaining, using the first polynomial in the second representation and the second polynomial in the second representation, an error-locator polynomial (ELP) in the second representation;
applying an additional CoV transformation to obtain the ELP in a third representation;
identifying a set of roots of the ELP in the third representation; and
using a combined transformation to identify, from the set of roots of the ELP in the third representation, a set of roots of the ELP in the first representation, wherein the combined transformation is based on the CoV transformation and the additional CoV transformation.

11. The method of claim 1, wherein the cryptographic operation comprises a McEliece decryption operation.

12. The method of claim 1, wherein the CoV transformation is generated using one or more random coefficients.

13. A system comprising:
a memory device; and
a processing device communicatively coupled to the memory device, the processing device to:
identify a first polynomial in a first representation, the first polynomial obtained using an input into a cryptographic operation;
identify a second polynomial in the first representation, the second polynomial obtained using a cryptographic key for the cryptographic operation;
apply a change-of-variable (CoV) transformation to the first polynomial in the first representation to obtain the first polynomial in the second representation;
apply the CoV transformation to the second polynomial to obtain the second polynomial in the second representation;
perform a joint operation using the first polynomial in the second representation and the second polynomial in the second representation; and
compute an output of the cryptographic operation using an output of the joint operation.

14. The system of claim 13, wherein the input into the cryptographic operation comprises a ciphertext and the output of the cryptographic operation comprises a plaintext encrypted in the ciphertext.

15. The system of claim 13, wherein the CoV transformation comprises an invertible transformation from a first variable to a second variable.

16. The system of claim 13, wherein to compute the output of the cryptographic operation, the processing device is to:
inverse-transform the output of the joint operation using an inverse of the CoV transformation; and
compute the output of the cryptographic operation using the inverse-transformed output of the joint operation.

17. The system of claim 13, wherein to perform the joint operation, the processing device is to execute at least one of:
an extended greatest common divisor (GCD) algorithm for the first polynomial in the second representation and the second polynomial in the second representation;
an extended half-GCD algorithm for the first polynomial in the second representation and the second polynomial in the second representation; or
an algorithm computing an inverse of one of (i) the first polynomial in the second representation or (ii) the second polynomial in the second representation modulo another one of (i) the first polynomial in the second representation or (ii) the second polynomial in the second representation.

18. The system of claim 13, wherein to perform the joint operation, the processing device is to:
obtain an error-locator polynomial (ELP) in the second representation using the first polynomial in the second representation and the second polynomial in the second representation; and
identify a set of roots of the ELP in the second representation.

19. The system of claim 18, wherein the processing device is further to:
use the CoV transformation to identify, from the set of roots of the ELP in the second representation, a set of roots of the ELP in the first representation.

20. The system of claim 13, wherein to perform the joint operation, the processing device is further to:
obtain, using the first polynomial in the second representation and the second polynomial in the second representation, an error-locator polynomial (ELP) in the second representation;
apply an additional CoV transformation to obtain the ELP in a third representation;
identify a set of roots of the ELP in the third representation; and
use a combined CoV transformation to identify, from the set of roots of the ELP in the third representation, a set of roots of the ELP in the first representation, wherein the combined transformation is based on the CoV transformation and the additional CoV transformation.

21. A non-transitory computer-readable storage medium storing instructions thereon that, when executed by a processing device, cause the processing device to:
identify a first polynomial in a first representation, the first polynomial obtained using an input into a cryptographic operation;
identify a second polynomial in the first representation, the second polynomial obtained using a cryptographic key for the cryptographic operation;
apply a change-of-variable (CoV) transformation to the first polynomial to obtain a the first polynomial in the second representation;
apply the CoV transformation to the second polynomial to obtain the second polynomial in the second representation;
perform a joint operation using the first polynomial in the second representation and the second polynomial in the second representation; and
compute an output of the cryptographic operation using an output of the joint operation.
